(19) United States
(12) Patent Application Publication
(10) Pub. No.: US 2016/0125359 A1
(43) Pub. Date: May 5, 2016

(54) INFORMATION PROCESSING DEVICE, INFORMATION PROCESSING SYSTEM, AND INFORMATION PROCESSING METHOD

(71) Applicant: PFU LIMITED, Ishikawa (JP)

(72) Inventor: Ichiro Fujioka, Ishikawa (JP)

(21) Appl. No.: 14/894,310

(22) PCT Filed: Jul. 4, 2013
(86) PCT No.: PCT/JP2013/068425

§ 371 Date: Nov. 25, 2015

(51) Int. Cl. G06Q 10/10; G06F 9/445

(52) U.S. Cl. CPC G06Q 10/10; G06F 8/65

(57) ABSTRACT

The purpose of this invention is to make a manual easier to use. This manual management device 7 selects which stored content data to display on the basis of information on hardware or software installed in or on a user terminal 3 and issues an instruction to update a manual using the selected content data. In accordance with said instruction, the user terminal 3 updates a displayed manual using manual content data stored in a database.

### FIELD

The invention relates to an information processing device, an information processing system, and an information processing method.

### BACKGROUND

Japanese Patent Application Laid-Open (JP-A) No. 2002-182811 discloses a software support system for supporting software to display a plurality of window screens on a screen of a computer such that processing may be performed on the respective window screens, the system including: ID acquisition portion that acquires an ID of the window screen currently being operated from among the unique IDs issued to the window screens; a user support database that accumulates support information pieces about the window screens in condition where they are correlated with the IDs unique to the window screens; search portion that searches the user support database based on the ID unique to the window screen currently being operated and acquired by the ID acquisition portion; and output portion that outputs the support information searched for.

Japanese Patent Application Laid-Open (JP-A) No. 1999-316636 discloses a manual display device that displays an initial setting process of a printer by directly activating a setup guide from a main body of a PC and installs a reference guide into the PC main body and then executes it to reference help information etc. about the printer such that updated information etc. of this help information in a Web server may be referenced appropriately.

### PRIOR ART DOCUMENT

### Patent Documents

Patent Document 1: JP-A No. 2002-182811

Patent Document 2: JP-A No. 1999-316636

### SUMMARY OF THE INVENTION

### Problems to be Solved by the Invention

The purpose of this invention is to make a manual easier to use.

### Solutions to the Problems

According to an aspect of the invention, there is provided an information processing device having: a storage unit configured to store content data of a manual about hardware or software; a selecting unit configured to select the content data to be displayed from the stored content data, based on information on the hardware or the software installed in or on the information processing device; and an updating unit configured to update the manual to be displayed on the information processing device by using the selected content data.

### Effect of the Invention

It is possible to make a manual easier to use.

### BRIEF DESCRIPTION OF THE DRAWINGS

FIG. 1 is a diagram illustrating a hardware configuration of a manual updating system 1;

FIG. 2 is a diagram illustrating a functional configuration of the manual updating system 1;

FIG. 3 is an explanatory diagram of a functional configuration of a local manual updating program 30;

FIG. 4 is an explanatory diagram of a functional configuration of a server manual updating program 70;

FIG. 5 is an explanatory flowchart of updated timing determining processing (S10);

FIG. 6 is an explanatory flowchart of manual updating processing (S11);

FIG. 7 is a diagram illustrating a table which determines to select contents;

FIG. 8 is a diagram illustrating a top page of a manual display screen 11;

FIG. 9A is a diagram illustrating a table of contents page of the manual;

FIG. 9B is a diagram illustrating some contents of the manual;

FIG. 10 is a diagram illustrating a functional configuration of a manual updating system 1 in variant 1;

FIG. 11 is a diagram illustrating a functional configuration of a local manual updating program 32 in the variant 1;

FIG. 12 is a diagram illustrating a functional configuration of a server manual updating program 72 in the variant 1;

FIG. 13 is a diagram illustrating a configuration of manual data;

FIG. 14 is a diagram illustrating a configuration of instruction data; and

FIG. 15 is an explanatory flowchart of manual updating processing (S20) in the variant 1.

### DESCRIPTION OF EMBODIMENTS

The following will describe an embodiment of the present invention with reference to the drawings.

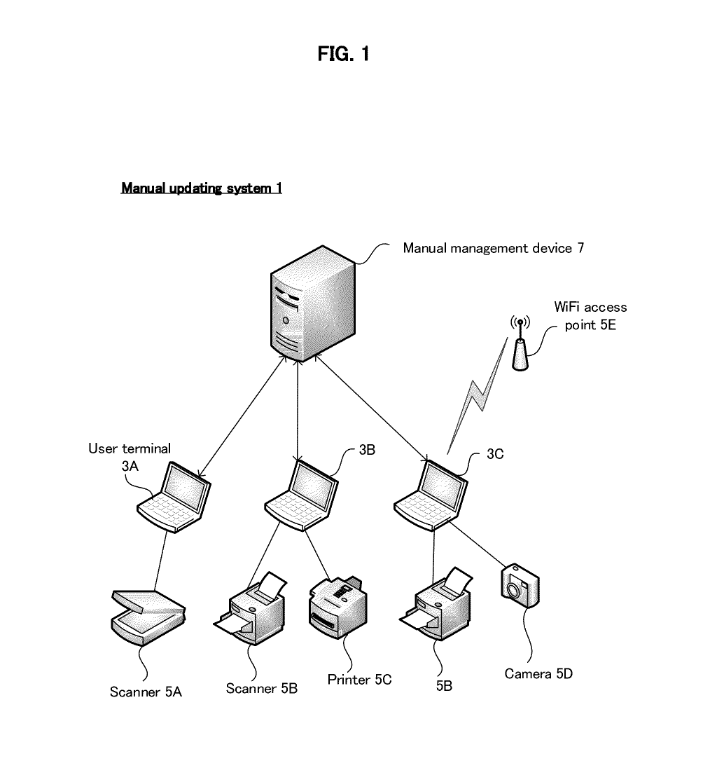

FIG. 1 is a diagram illustrating a hardware configuration of a manual updating system 1.

As illustrated in FIG. 1, the manual updating system 1 of the embodiment has user terminals 3A to 3C, peripherals 5A to 5E, and a manual management device 7.

A user terminal 3 is one example of an information processing device according to the invention and a computer operated by a user. For example, the user terminal 3 is the computer including a central processor, a main storage, an external storage, an input device, and a monitor.

The peripherals 5 are devices connected to the user terminal 3 by wired or wireless communication and, for example, a scanner (a flatbed scanner 5A, a scanner 5B with an automatic document feeder), a printer 5C, a camera 5D, or a WiFi access point 5E (such as a wireless router).

The manual management device 7 is a computer that manages a manual displayed on the user terminal 3. The manual management device 7 connects to the user terminal 3 via a network such as the Internet.

In the above system configuration, the user operates the user terminal 3 and permits the user terminal 3 to display the manual of hardware or software installed in or on the user terminal 3 and refers to the manual. In the present example, as a specific example, a case is given in which the user permits the user terminal 3 to display the manual of the scanner (more specifically “scanner SS”) connected to the user terminal 3.

Depending on the environment of “scanner SS”, the manual management device 7 selects the contents of the manual to be displayed when the user permits the user terminal 3 to display the manual of “scanner SS”. The environment of “scanner SS” refers to the other hardware (a printer, a camera, or a WiFi access point, etc.) installed in or on the user terminal 3 and the other software (operating system, driver software, or application software, etc.) installed in or on the user terminal 3.

The user terminal 3 displays the manual in which the contents are selected in response to the instruction from the manual management device 7.

Although in the following embodiment, as a specific example, a case is given in which the user terminal 3 selects content data of the manual and the manual management device 7 selects items of the table of contents, the invention is not limited to it; for example, the user terminal 3 may select both the contents and the items of the table of contents or the manual management device 7 may select both the contents and the items of the table of contents.

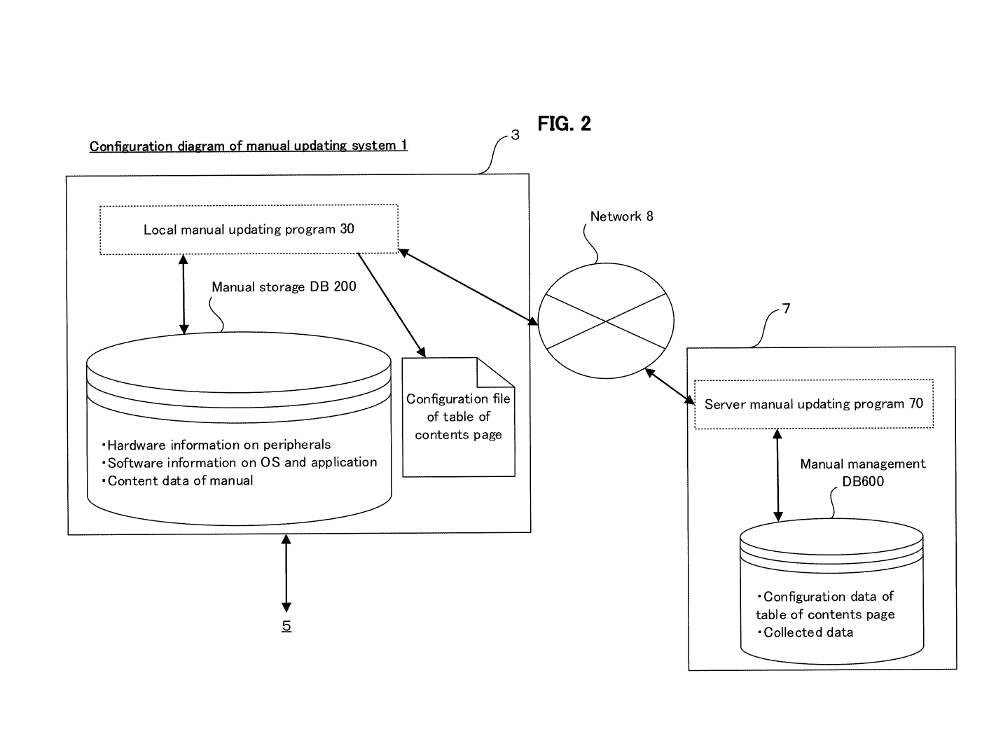

FIG. 2 is a diagram illustrating a functional configuration of the manual updating system 1.

As illustrated in FIG. 2, the user terminal 3 has the local manual updating program 30 and a manual storage database 200 (manual storage DB200).

The local manual updating program 30 updates the displayed manual on the user terminal 3. The local manual updating program 30 in the present embodiment updates the manual, by using a configuration file of the table of contents page received from the manual management device 7 and the content data selected by the local manual updating program 30.

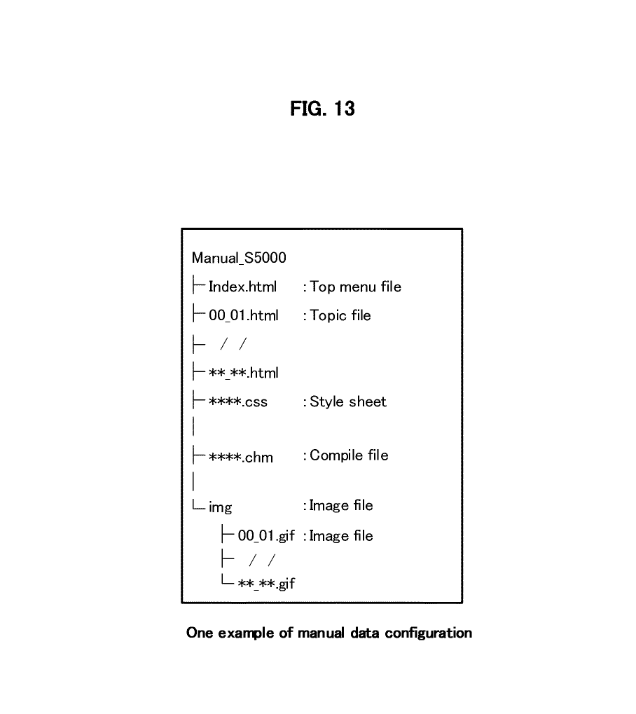

The manual storage DB200 stores the content data of the manual, hardware information on the peripherals 5, and software information on software. The content data of the manual are the data used when the contents of the manual are displayed. For example, one of the content data of the manual is an HTML file as illustrated in FIG. 13. In the example, all the content data are stored in the manual storage DB200. That is, manual information based on a plurality of operating environments such as manual information on a plurality of models of scanners, manual information based on a plurality of operating systems, or manual information on a plurality of applications are stored in the manual storage DB200. Further, the software information includes information on an operating system and an application.

As illustrated in FIG. 2, the manual management device 7 has a server manual updating program 70 and a manual management database 600 (manual management DB600).

The server manual updating program 70 instructs to select contents to display in the manual and instructs to display only the selected contents on the user terminal 3, on the basis of the collected data (information on the operating environment on the user terminal 3) collected by the user terminal 3. The server manual updating program 70 in the present embodiment generates the configuration data of the table of contents page in which the contents are selected on the basis of the collected data and transmits the generated configuration data of the table of contents page to the user terminal 3.

The manual management DB600 stores the configuration data of the table of contents page and the data collected by the user terminal 3.

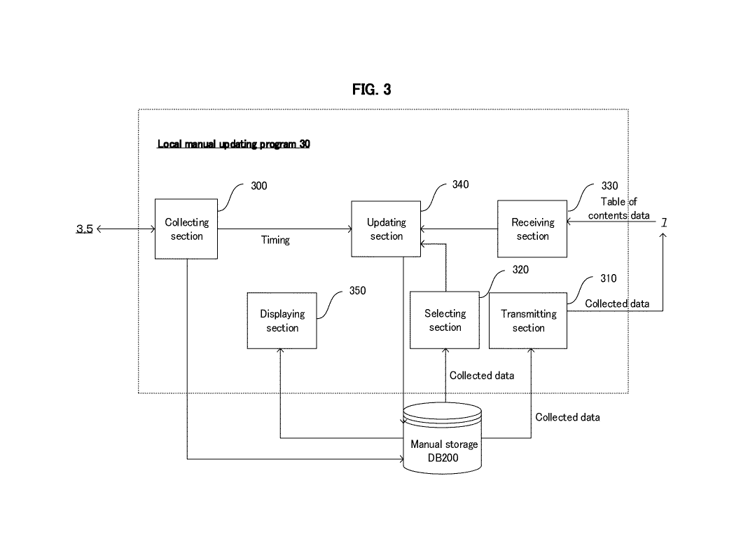

FIG. 3 is an explanatory diagram of a functional configuration of the local manual updating program 30.

As illustrated in FIG. 3, the local manual updating program 30 has a collecting section 300, a transmitting section 310, a selecting section 320, a receiving section 330, an updating section 340, and a displaying section 350. The local manual updating program 30 is installed in or on the user terminal 3 via a recording medium such as a CD-ROM, for example.

In the local manual updating program 30, the collecting section 300 collects hardware information of the user terminal 3 (that is, information on hardware connected to the user terminal 3) and software information of the user terminal 3 (that is, information on software installed in or on the user terminal 3). The collecting section 300 in the present embodiment collects information on peripherals (the devices which can cooperate with the scanner which is a target of the manual, such as another scanner, the printer, the camera, etc.) connected to the user terminal 3, information on the operating system running on the user terminal 3, information on the application (specially, the application which can cooperate with the scanner which is the target of the manual.) installed in or on the user terminal 3, and information on setting information of WiFi connection of the user terminal 3.

The transmitting section 310 transmits the information (including information on the hardware and the software) collected by the collecting section 300 to the manual management device 7.

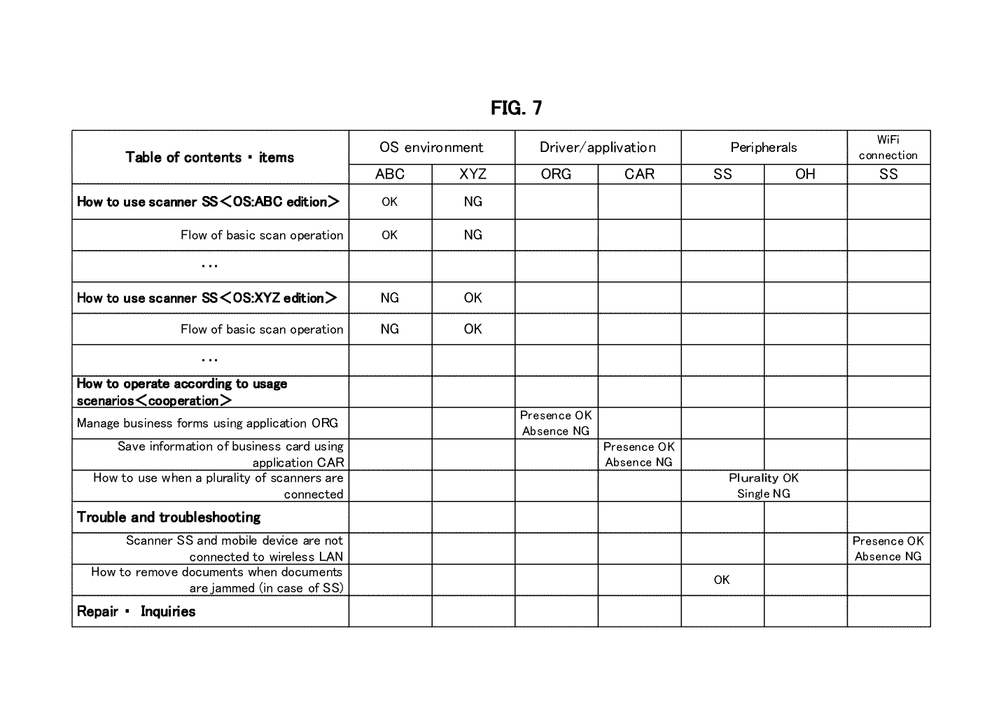

The selecting section 320 selects the content data of the manual on the basis of the information collected by the collecting section 300. The selecting section 320 in the present embodiment determines the displayed or hidden contents by using the table to be described later referring to FIG. 7.

The receiving section 330 receives the configuration data of the table of contents page transmitted from the manual management device 7 and outputs the received configuration data of the table of contents page to the updating section 340.

The updating section 340 updates the manual by using the content data which the selecting section 320 selects from the content data of the manual stored in the manual storage DB200. The updating section 340 in the present embodiment updates the manual, on the basis of the content data selected by the selecting section 320 and the configuration data of the table of contents page received by the receiving section 330.

The displaying section 350 controls the monitor of the user terminal 3 and displays the manual updated by the updating section 340.

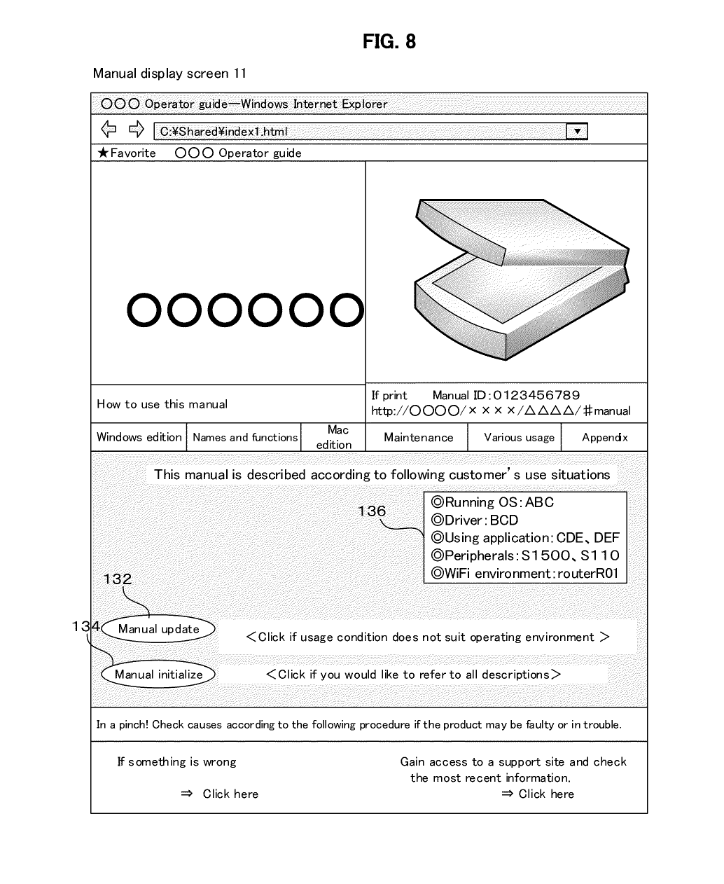

The displaying section 350 in the present embodiment displays a manual display screen 11 to be described later referring to FIG. 8 and permits the user terminal 3 to display the updated manual in response to requests of the user.

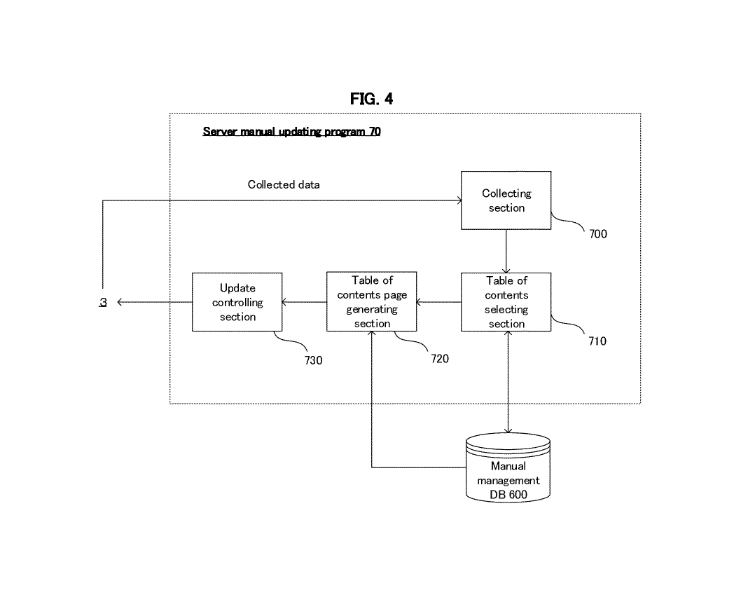

FIG. 4 is an explanatory diagram of a functional configuration of a server manual updating program 70.

As illustrated in FIG. 4, the server manual updating program 70 has a collecting section 700, a table of contents selecting section 710, a table of contents page generating section 720, and an update controlling section 730. The server manual updating program 70 is installed in or on the manual management device 7 via a recording medium such as a CD-ROM, for example.

The collecting section 700 collects information on the hardware or the software installed in or on the user terminal 3. The collecting section 700 in the present embodiment receives the collected data (the information on the hardware and the software) transmitted from the user terminal 3.

The table of contents selecting section 710 selects the contents of the manual to be displayed on the user terminal 3 on the basis of the information collected by the collecting section 700. The table of contents selecting section 710 in the present embodiment selects items to be displayed on the table of contents page of the manual, on the basis of the collected data received from the collecting section 700 and the table illustrated in FIG. 7.

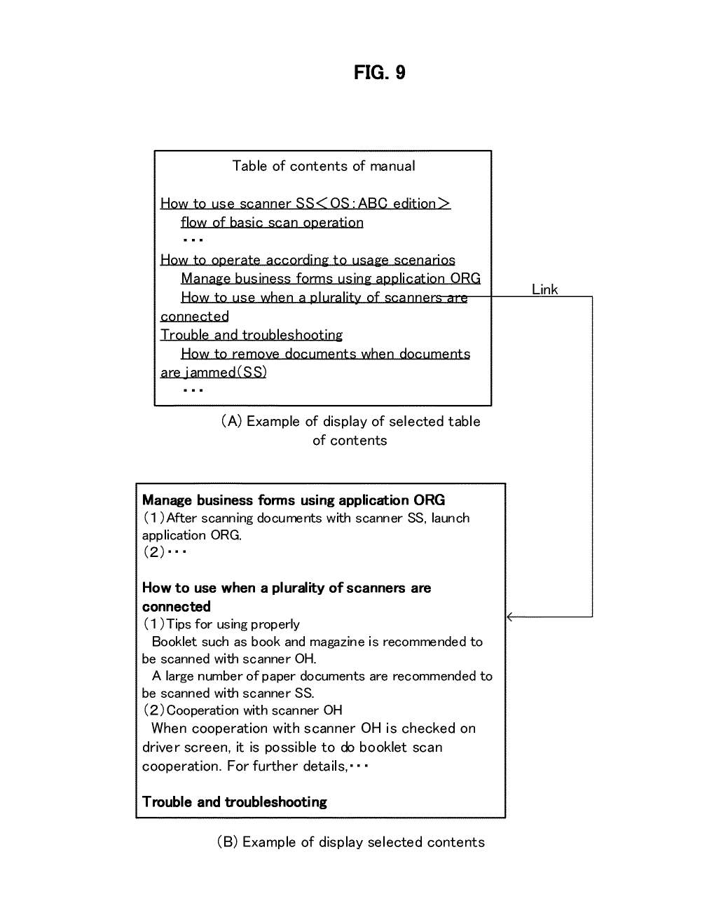

The table of contents page generating section 720 generates the table of contents page which includes only the contents selected by the table of contents selecting section 710. The table of contents page generating section 720 in the present embodiment generates the table of contents page (HTML file) illustrated in FIG. 9A, on the basis of the configuration data of the table of contents page stored in the manual management DB600 and the items selected by the table of contents selecting section 710. The generated configuration data of the table of contents page include only the items selected by the table of contents selecting section 710 and the other items are deleted.

The update controlling section 730 instructs the user terminal 3 to update the manual by using the contents selected by the table of contents selecting section 710. The update controlling section 730 in the present embodiment transmits the configuration data of the table of contents page generated by the table of contents page generating section 720 to the user terminal 3, thereby permitting the user terminal 3 to update the manual in which the table of contents page is made of the generated configuration data of the table of contents page. In the table of contents page, only the selected contents are displayed. As a result, only the selected contents are displayed on the user terminal 3.

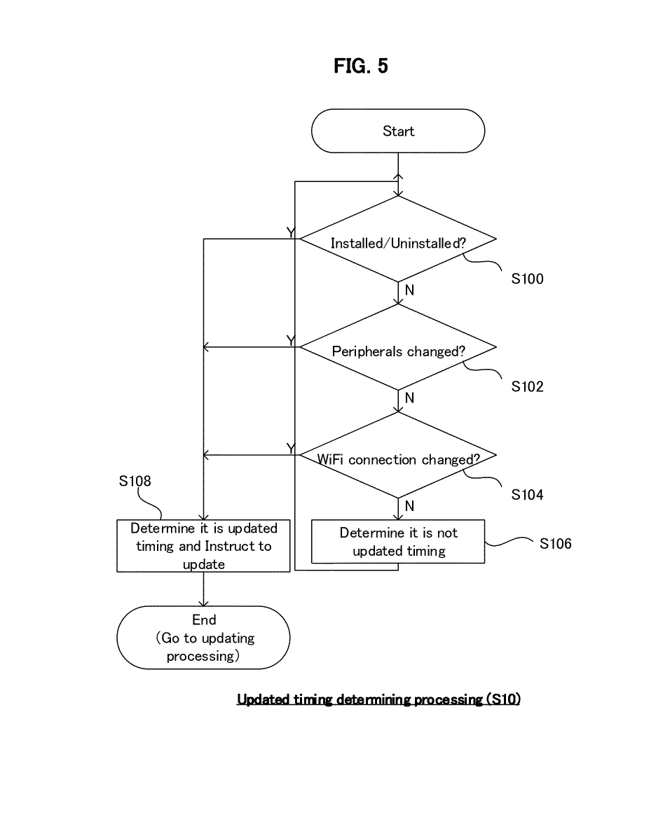

FIG. 5 is an explanatory flowchart of updated timing determining processing (S10).

As illustrated in FIG. 5, in step 100 (S100), the collecting section 300 of the user terminal 3 collects the information on the hardware and the software of the user terminal 3 at the predetermined timing and outputs the collected information (the collected data) to the updating section 340 and the manual storage DB200.

The updating section 340 determines whether the software is installed or uninstalled in or on the user terminal 3 on the basis of the collected data inputted from the collecting section 300. If it is determined that the software is installed or uninstalled, the updated timing determining processing (S10) shifts to the processing in S108 and, otherwise, shifts to the processing in S102.

In step 102 (S102), the updating section 340 determines whether the peripherals (hardware) in the user terminal 3 are powered on or off on the basis of the collected data inputted from the collecting section 300. If it is determined that the peripherals are powered on or off, the updated timing determining processing (S10) shifts to the processing in S108 and, otherwise, shifts to the processing in S104.

In step 104 (S104), the updating section 340 determines whether new settings or changed settings of the WiFi connection are performed in the user terminal 3 on the basis of the collected data inputted from the collecting section 300. If it is determined that the new settings or the changed settings of the WiFi connection are performed, the updated timing determining processing (S10) shifts to the processing in S108 and, otherwise, shifts to the processing in S106.

In step 106 (S106), the updating section 340 determines that it is not the updated timing and returns to the processing in S100 after waiting for predetermined time.

In step 108 (S108), the updating section 340 determines that it is the updated timing and shifts to manual updating processing (S11). After completing the manual updating processing (S11), the updating section 340 returns to the processing in S100.

In the manual management device 7, the collecting section 700 performs the processing of the above collecting section 300 and updating section 340 and determines the updated timing of the table of contents page.

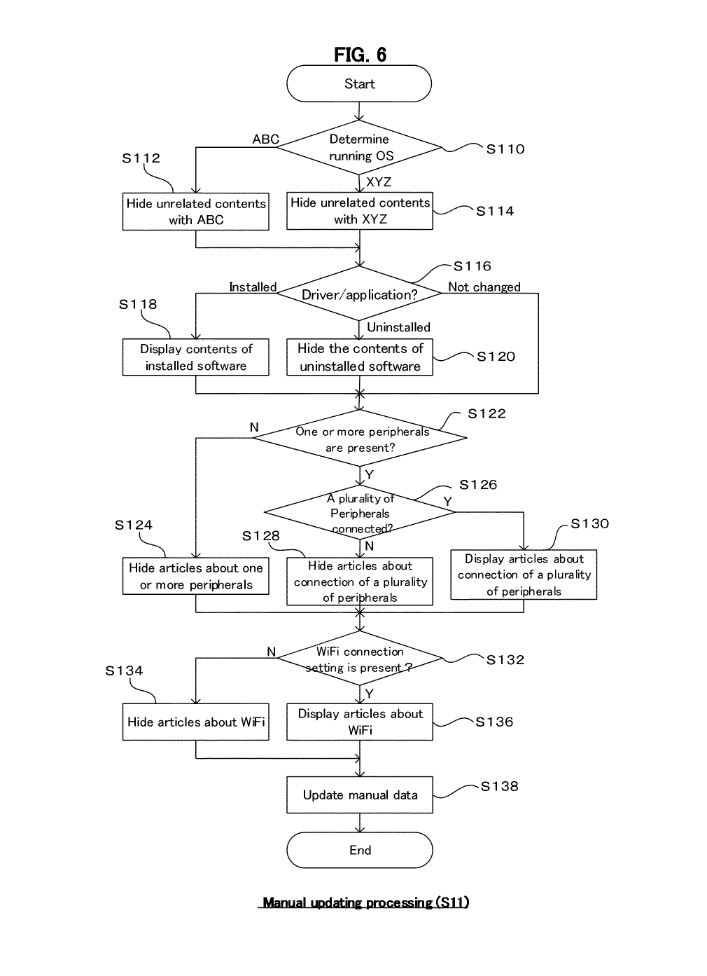

FIG. 6 is an explanatory flowchart of the manual updating processing (S11).

As illustrated in FIG. 6, in step 110 (S110), the selecting section 320 of the user terminal 3 determines a type of the operating system running in the user terminal 3. If the operating system is “ABC”, the manual updating processing (S11) shifts to the processing in S112 and, if the operation system is “XYZ”, shifts to the processing in S114.

In step 112 (S112), the selecting section 320 instructs the updating section 340 to hide the unrelated contents with the operating system “ABC” from the manual.

In step 114 (S114), the selecting section 320 instructs the updating section 340 to hide the unrelated contents with the operating system “XYZ” from the manual.

In Step 116 (S116), the selecting section 320 determines whether a driver or an application newly installed in or on the user terminal 3 is present. If the newly installed driver or application is present, the manual updating processing (S11) shifts to the processing in S118.

Further, the selecting section 320 determines whether the driver or the application uninstalled from the user terminal 3 is present. If the uninstalled driver or application is present, the manual updating processing (S11) shifts to the processing in S120.

If the newly installed driver or application and the uninstalled driver or application are not present, the manual updating processing (S11) shifts to the processing in S122.

In step 118 (S118), the selecting section 320 instructs the updating section 340 to display the contents (more specifically, the articles based on the assumption that the driver or application is available) of the newly installed driver or application in the manual.

In step 120 (S120), the selecting section 320 instructs the updating section 340 to hide the contents of the uninstalled driver or application from the manual.

In step 122 (S122), the selecting section 320 determines whether one or more peripherals are connected to the user terminal 3. If the one or more peripherals are connected, the manual updating processing (S11) shifts to the processing in S126, and if the one or more peripherals are not connected, shifts to the processing in S124.

In step 124 (S124), the selecting section 320 instructs the updating section 340 to hide the contents (more specifically, the articles based on the assumption that the one or more peripherals are available) of the one or more peripherals from the manual.

In step 126 (S126), the selecting section 320 determines whether a plurality of peripherals are connected to the user terminal 3. If the peripherals are connected, the manual updating processing (S11) shifts to the processing in S130, and if only one peripheral is connected, shifts to the processing in S128.

In step 128 (S128), the selecting section 320 instructs the updating section 340 to display the contents (more specifically, the articles based on the assumption that the connected peripheral is available) of the connected peripheral in the manual and to hide the contents of the connection of the peripherals from the manual.

In step 130 (S130), the selecting section 320 instructs the updating section 340 to display the contents of the connected peripherals in the manual and, moreover, to display the contents (more specifically, the articles based on the assumption that the peripherals are available) of the connection of the peripherals in the manual. The contents of the connection of the peripherals are articles to prompt to use properly the peripherals (for example, information on the difference in functions) or articles to explain a cooperation function (for example, a copy function by a scanner and a printer) of the peripherals.

In step 132 (S132), the selecting section 320 determines whether the WiFi connection setting is present in the user terminal 3. If the WiFi connection setting is present, the manual updating processing (S11) shifts to the processing in S136, and if the WiFi connection setting is not present, shifts to the processing in S134.

In step 134 (S134), the selecting section 320 instructs the updating section 340 to hide the contents (more specifically, the articles based on the assumption that the WiFi connection is available) of the WiFi connection from the manual.

In step 136 (S136), the selecting section 320 instructs the updating section 340 to display the contents of the WiFi connection in the manual.

In step 138 (S138), in response to the instruction from the selecting section 320, the updating section 340 generates the content data of the manual in which the contents to be displayed are selected and integrates the generated content data and the configuration file of the table of contents page (the table of contents data in which items are selected) received from the manual control device 7, thereby updating the manual. As illustrated in FIG. 9, the updated manual has the items of the table of contents and contents (articles) which are selected.

In this flowchart, although the embodiment explains that the contents are displayed or hidden, the content data themselves may be added or deleted.

FIG. 7 is a diagram illustrating a table which determines to select contents. In the table illustrated in FIG. 7, whether the contents of the manual (items) are displayed or hidden is associated with the type of the operating system, the driver, the application, and the peripherals and the presence or absence of the WiFi setting. In the table, “OK” indicates that the contents should be added to or displayed on the manual and “NG” indicates that the contents should be deleted or hidden from the manual. The unmarked item indicates that it does not affect whether the contents are displayed or hidden.

FIG. 8 is a diagram illustrating a top page of a manual display screen 11.

As illustrated in FIG. 8, the top page of the manual display screen 11 includes a manual updating button 132, a manual initializing button 134, and a usage condition display region 136.

The manual updating button 132 is the button which instructs the collecting section 300 to update the information on the hardware and the software. That is, when the manual updating button 132 is clicked, the information on the hardware and the software are forcibly updated.

The manual initializing button 134 is the button which instructs the updating section 340 to initialize the manual. That is, when the manual initializing button 134 is clicked, the previous manual in which the contents are not selected by the selecting section 320 is displayed.

The usage condition display region 136 is the region where the information on the hardware and the software selected by the collecting section 300 is displayed. In the usage condition display region 136 in the present embodiment, the type of the operating system, the driver, the application, and the peripherals and WiFi environment are displayed. Further, when the manual updating button 132 is clicked, the display of the usage condition display region 136 is updated.

FIG. 9A illustrates a table of contents page of the manual and FIG. 9B illustrates some contents of the manual.

As illustrated in FIG. 9A, in the table of contents page of the manual, the items of the selected manual are arranged. In each item arranged in the table of contents page, link information is embedded and when the user selects some items, the contents of the selected items are displayed as FIG. 9B.

As illustrated in FIG. 9, by selecting the items of the table of contents page and the contents of the manual, only the important information for the user is displayed and it makes a manual easier to use.

As described above, according to the manual updating system 1 of the present embodiment, it makes the manual easier to use by selecting the contents of the manual in accordance with the operating environment of the user. For example, when the user refers to a manual which describes all functions, detailed procedures, or precautions about products, it takes time to search necessary information and the information may not be searched. In particular, the common manual to types of equipment such as an application is much more difficult to use when all functional differences between the types of equipment are described and differences between displays, functions, and operations are described for each type of the operating systems and complex and a large number of wireless-related articles are described although the user does not connect to wireless network. However, according to the manual updating system 1 of the present embodiment, the manual is easier to use since the contents that match the operating environment of the user are dynamically selected. Accordingly, in order to increase the possibilities to solve the problem by the manual, it can be expected to reduce the number of calls from users and support costs for product vendors.

Further, regardless of the familiar manual, since new contents are added according to the change of the operating environment, it can be expected to utilize the manual in the long term.

### [Variant 1]

In the above embodiment, the user terminal 3 selects the contents and the manual management device 7 selects the items of the table of contents. In variant 1, it is explained that the manual management device 7 selects the items of the table of contents and the contents.

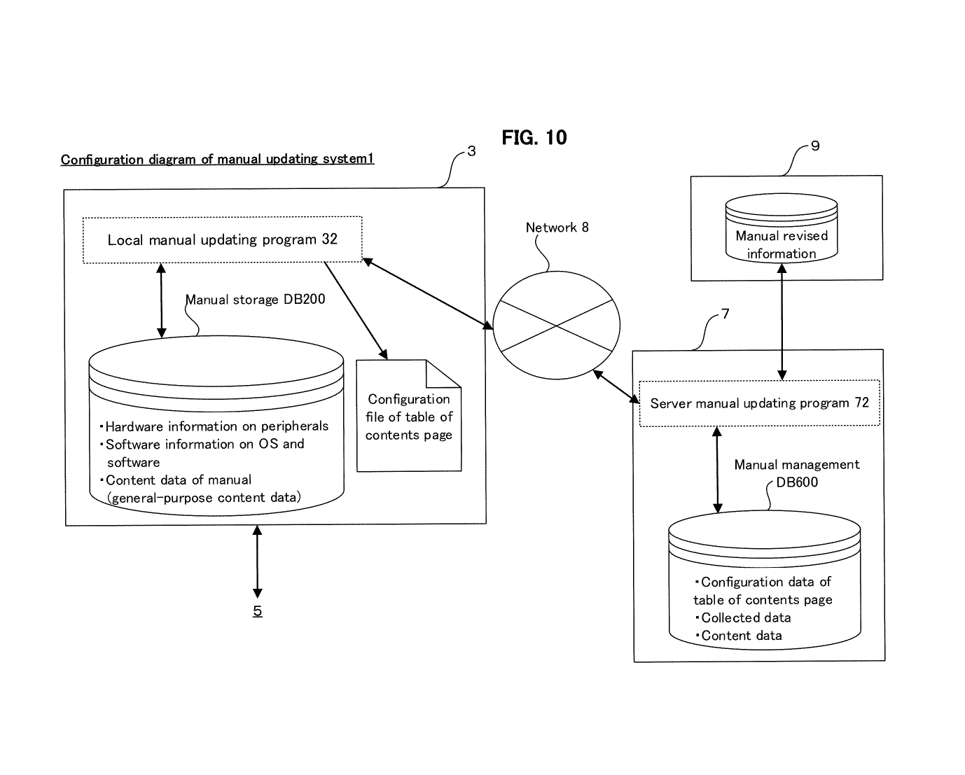

FIG. 10 is a diagram illustrating a functional configuration of a manual updating system 1 in the variant 1.

As illustrated in FIG. 10, the manual updating system 1 in the variant 1 has a configuration in which a manual revising device 9 is added to the manual updating system of the above embodiment. The manual revising device 9 revises the manual in response to an operation of a manual editor. More specifically, in response to the operation of the manual editor, the manual revising device 9 generates instruction data which instruct to add, to delete, and to replace contents and the revised content data (hereinafter referred to as the revised data). After that, the manual revising device 9 stores the instruction data and the revised data as manual revised information.

Further, in the manual storage DB200 of the user terminal 3, not all the manual content data but only the general-purpose contents are stored.

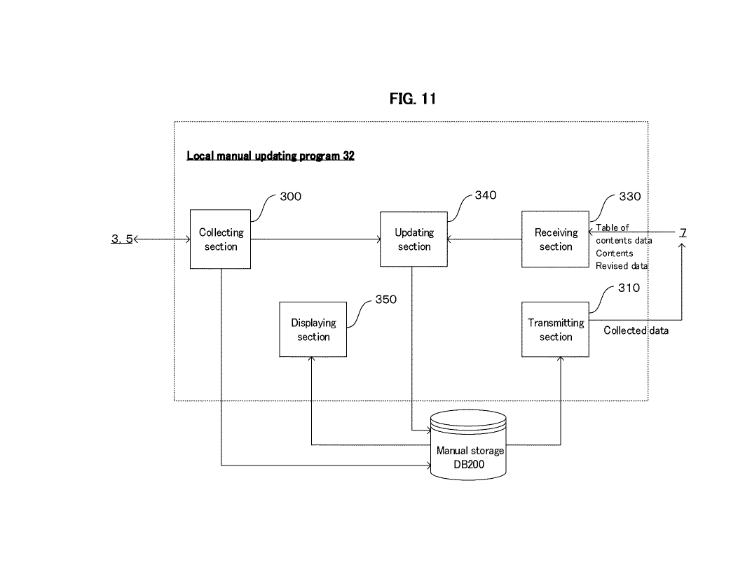

FIG. 11 is a diagram illustrating a functional configuration of a local manual updating program 32 in the variant 1.

As illustrated in FIG. 11, the local manual updating program 32 in the variant 1 has a configuration in which the selecting section 320 is deleted from the local manual updating program 30 of the above embodiment. Unlike the above embodiment, the local manual updating program 32 in the variant 1 doesn't select contents by itself. An updating section 340 generates the manual in which the contents are selected in accordance with the update instruction data (which may include the instruction data and the revised data) received via a receiving section 330.

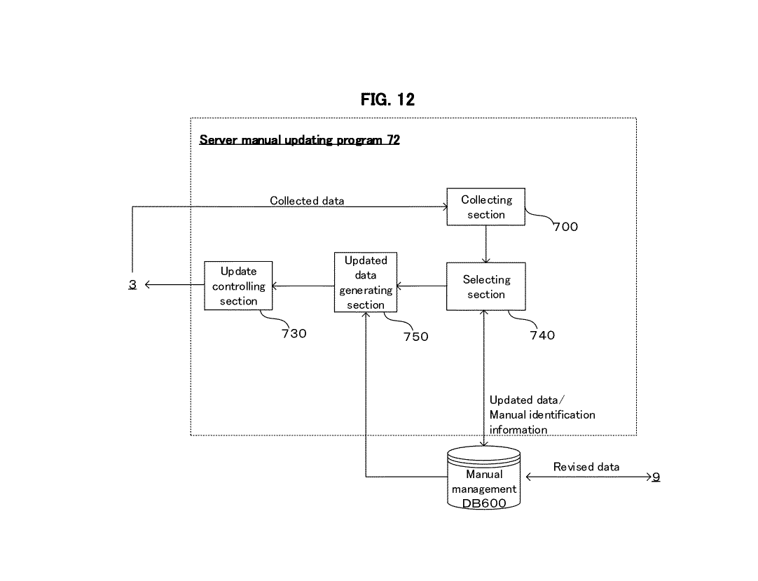

FIG. 12 is a diagram illustrating a functional configuration of a server manual updating program 72 in the variant 1.

As illustrated in FIG. 12, the server manual updating program 72 in the variant 1 has a configuration in which the table of contents selecting section 710 is replaced with a selecting section 740 and the table of contents page generating section 720 is replaced with an updated data generating section 750 in comparison with the configuration of the server manual updating program 70 of the above embodiment.

In the server manual updating program 72 in the variant 1, the selecting section 740 selects the content data of the manual (specifically, both the items of the table of contents and the contents) on the basis of the collected data received from the user terminal 3.

On the basis of the contents and the items of the table of contents selected by the selecting section 740 and the manual revised information generated by the manual revising device 9, the updated data generating section 750 generates the instruction data and revised data which realize both contents selection and manual revision. More specifically, the updated data generating section 750 generates the instruction data (instruct to delete the contents) which select the contents, the instruction data and the configuration file of the table of contents page which replace the table of contents page, the instruction data (instruct to add the contents or to replace the old contents) which revise the contents, and the revised data (the added or replaced contents).

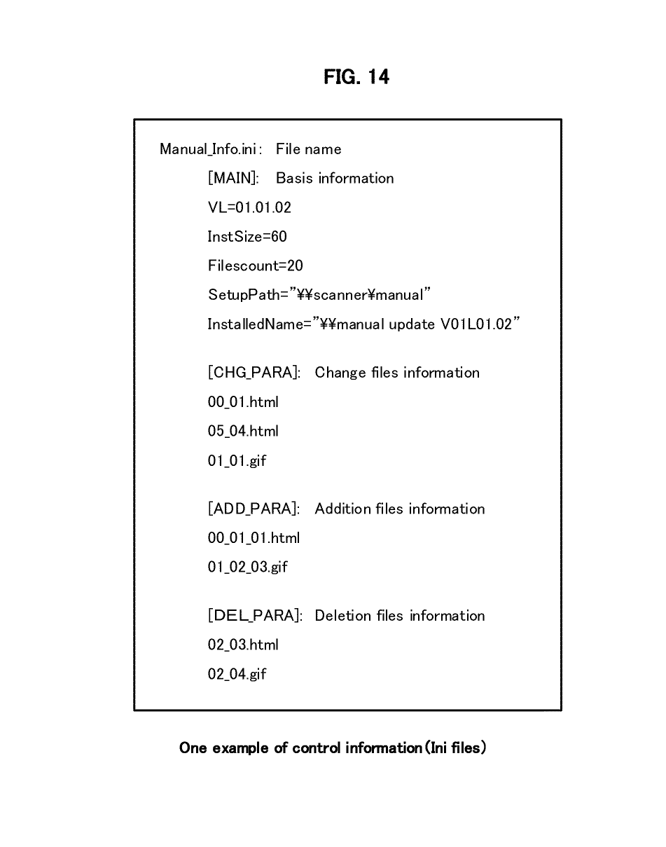

More specifically, if a collecting section 700 receives the collected data from the user terminal 3, the selecting section 740 determines the added or deleted contents on the basis of the collected data and the updated data generating section 750 generates the instruction data which instruct to add or to delete the contents. Further, if the manual revising device 9 registers the manual revised information on some contents in the manual management DB 600, the updated data generating section 750 generates the instruction data to add or replace the contents, and the revised content data, in accordance with the registered manual revised information. As illustrated in FIG. 13, the contents of the manual are composed of HTML format. Further, the instruction data, as illustrated in FIG. 14, include one or more of the following: “change files information” which instructs to replace contents, “addition files information” which instructs to add contents, or “deletion files information” which instructs to delete contents.

Further, as is the case with the above embodiment, the updated data generating section 750 in the variant 1 generates the configuration file of the table of contents page in which items are selected. By generating the instruction data which instruct to replace with the generated configuration file of the table of contents page, the updated data generating section 750 instructs to update the table of contents page.

The update controlling section 730 transmits the instruction data generated by the updated data generating section 750 to the user terminal 3 and instructs to update the manual. Further, if there is the revised content data, the update controlling section 730 transmits the instruction data and the revised content data (the revised data) to the user terminal 3.

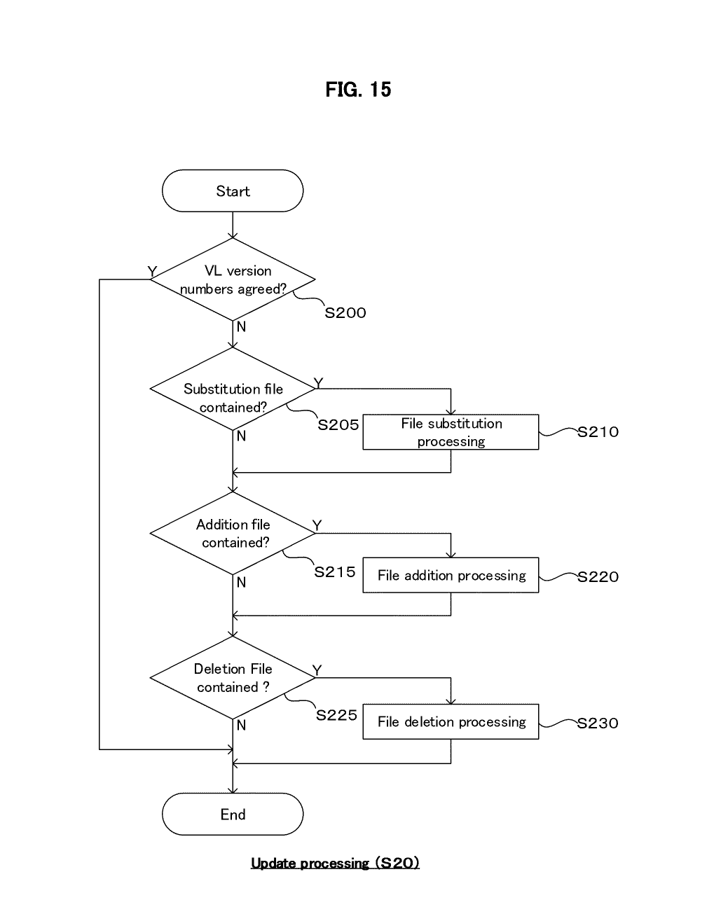

FIG. 15 is an explanatory flowchart of manual updating processing (S20) in the variant 1.

As illustrated in FIG. 15, in step 200 (S200), the receiving section 330 receives the instruction data and the revised data if there is newly-revised data (revised content data), from the manual management device 7.

Referring to the instruction data received by the receiving section 330, the updating section 340 compares the version number indicated by “VL” contained in control information of the instruction data illustrated in FIG. 14 to the version number of a manual held in the manual storage DB200.

The updating processing (S20) shifts to the processing in S205 if these manual version numbers disagree and ends if they agree.

In step 205 (S205), the updating section 340 confirms “CHG_PARA” in the control information included in the instruction data.

The updating processing (S20) shifts to the processing in S210 if substitution files information is described in “CHG_PARA” and shifts to the processing in S215 if it is not described.

In step 210 (S210), the updating section 340 substitutes a file described in “CHG_PARA” in the control information for an existing file of a manual (HTML version) held in the manual storage DB200.

In step 215 (S215), the updating section 340 confirms “ADD_PARA” in the control information.

The updating processing (S20) shifts to the processing in S220 if addition files information is described in “ADD_PARA” and shifts to the processing in S225 if it is not described.

In step 220 (S220), the updating section 340 adds a file described in “ADD_PARA” in the control information to the manual (HTML version) held in the manual storage DB200.

In step 225 (S225), the updating section 340 confirms “DEL_PARA” in the control information.

The updating processing (S20) shifts to the processing in S230 if deletion files information is described in “DEL_PARA” and ends if it is not described.

In step 230 (S230), the updating section 340 deletes a file described in “DEL_PARA” in the control information from the manual (HTML version) held in the manual storage DB200.

As described above, the user terminal 3 updates the manual on the basis of the instruction data. In the result, the manual that has the selected content data is updated.

According to the variant 1, the data size of the manual on the user terminal 3 can be smaller. Further, they are realized by having the mechanism for revising and selecting contents in common.

What is claimed is:

1. An information processing device comprising:
a storage unit configured to store content data of a manual about hardware or software;
a selecting unit configured to select content data to be displayed from the stored content data, based on information on the hardware or the software installed in or on the information processing device; and
an updating unit configured to update the manual to be displayed on the information processing device by using the selected content data.

2. The information processing device according to claim 1, further comprising
a collecting unit configured to collect information on the other hardware or the other software installed in or on the information processing device, wherein
the selecting unit selects content data of the manual, based on the information on the other hardware or the other software collected by the collecting unit.

3. The information processing device according to claim 2, wherein
the updating unit updates the manual, at least when the hardware or the software is installed and uninstalled.

4. The information processing device according to claim 3, wherein
the updating unit updates the manual when an initial setting of network connection is completed.

5. The information processing device according to claim 4, wherein
the updating unit updates the manual when the other hardware is installed and powered on.

6. The information processing device according to claim 5, wherein:
the collecting unit collects information on an operating system installed in or on the information processing device or information on the other software which cooperates with the hardware or the software in the information processing device; and
the selecting unit selects content data to be displayed, based on the collected information on the operating system or the other software.

7. The information processing device according to claim 5, wherein:
the collecting unit collects information on the other hardware connected to the information processing device to which the hardware is connected simultaneously; and
the selecting unit selects content data to be displayed, based on the collected information on the other hardware.

8. The information processing device according to claim 7, wherein:
the collecting unit collects information on a scanner connected to the information processing device;
if a plurality of scanners are connected to the information processing device, the selecting unit adds to the manual information which prompts to use the scanners properly or information on cooperation of the scanners; and
if the number of scanners connected to the information processing device is one or less, the selecting unit deletes from the manual the information which prompts to use properly and the information on the cooperation of the scanners.

9. The information processing device according to claim 1, wherein:
the selecting unit determines hidden content data from the stored content data; and
the updating unit deletes link information which links the hidden content data from the other content data or a table of contents data.

10. An information processing system comprising:
an information processing device and a manual management device, wherein
the manual management device includes:
a selecting unit configured to select content data to be displayed from stored content data, based on information on hardware or software installed in or on the information processing device; and
an update controlling unit configured to instruct to update a manual by using the content data selected by the selecting unit, and wherein
the information processing device includes:
a storage unit configured to store the content data of the manual; and
an updating unit configured to update the manual displayed on the information processing device, in accordance with the instruction from the update controlling unit.

11. An information processing method of a manual management device selecting content data to be displayed from stored content data, based on hardware or software installed in or on an information processing device, wherein
the manual management device instructs to update a manual by using the selected content data; and
the information processing device updates displayed manual by using the content data of the manual stored in a database, in accordance with the instruction from the manual management device.
